(19) United States
(12) Patent Application Publication
(10) Pub. No.: US 2013/0127434 A1
(43) Pub. Date: May 23, 2013

(54) Coupled Inductor Arrays And Associated Methods

(71) Applicant: Alexandr Ikriannikov, Castro Valley, CA (US)

(72) Inventor: Alexandr Ikriannikov, Castro Valley, CA (US)

(21) Appl. No.: 13/303,062

(22) Filed: Nov. 22, 2011

(51) Int. Cl. H01F 30/12; G05F 1/618

(52) U.S. Cl. 323/283; 336/12

(57) ABSTRACT

A coupled inductor array includes a magnetic core and N windings, where N is an integer greater than one. The magnetic core has opposing first and second sides, and a linear separation distance between the first and second sides defines a length of the magnetic core. The N windings pass at least partially through the magnetic core in the lengthwise direction, and each of the N windings forms a loop in the magnetic core around a respective winding axis. Each winding axis is generally perpendicular to the lengthwise direction and parallel to but offset from each other winding axis. Each winding has opposing first and second ends extending towards at least the first and second sides of the magnetic core, respectively. One possible application of the coupled inductor array is in a multi-phase switching power converter.

### BACKGROUND

It is known to electrically couple multiple switching subconverters in parallel to increase switching power converter capacity and/or to improve switching power converter performance. A multi-phase switching power converter typically performs better than a single-phase switching power converter of otherwise similar design. In particular, the out-of-phase switching in a multi-phase converter results in ripple current cancellation at the converter output filter and allows the multi-phase converter to have a better transient response than an otherwise similar single-phase converter.

As taught in U.S. Pat. No. 6,362,986 to Schultz et al., which is incorporated herein by reference, a multi-phase switching power converter's performance can be improved by magnetically coupling the energy storage inductors of two or more phases. Such magnetic coupling results in ripple current cancellation in the inductors and increases ripple switching frequency, thereby improving converter transient response, reducing input and output filtering requirements, and/or improving converter efficiency, relative to an otherwise identical converter without magnetically coupled inductors.

Two or more magnetically coupled inductors are often collectively referred to as a “coupled inductor” and have associated leakage inductance and magnetizing inductance values. Magnetizing inductance is associated with magnetic coupling between windings; thus, the larger the magnetizing inductance, the stronger the magnetic coupling between windings. Leakage inductance, on the other hand, is associated with energy storage. Thus, the larger the leakage inductance, the more energy stored in the inductor. As taught in Schultz et al., larger magnetizing inductance values are desirable to better realize the advantages of using a coupled inductor, instead of discrete inductors, in a switching power converter. Leakage inductance, on the other hand, typically must be within a relatively small value range. In particular, leakage inductance must be sufficiently large to prevent excessive ripple current magnitude, but not so large that converter transient response suffers.

### SUMMARY

In an embodiment, a coupled inductor array includes a magnetic core and N windings, where N is an integer greater than one. The magnetic core has opposing first and second sides, and a linear separation distance between the first and second sides defines a length of the magnetic core. The N windings pass at least partially through the magnetic core in the lengthwise direction, and each of the N windings forms a loop in the magnetic core around a respective winding axis. Each winding axis is generally perpendicular to the lengthwise direction and parallel to but offset from each other winding axis. Each winding has opposing first and second ends extending towards at least the first and second sides of the magnetic core, respectively.

In an embodiment, a multi-phase switching power converter includes a coupled inductor and N switching circuits, where N is an integer greater than one. The coupled inductor includes a magnetic core having opposing first and second sides, and a linear separation distance between the first and second sides defines a length of the magnetic core. The N windings pass at least partially through the magnetic core in the lengthwise direction, and each of the N windings forms a loop in the magnetic core around a respective winding axis. Each winding axis is generally perpendicular to the lengthwise direction and parallel to but offset from each other winding axis. Each winding has opposing first and second ends extending toward at least the first and second sides of the magnetic core, respectively. Each switching circuit is adapted to be capable of repeatedly switching the first end of a respective one of the N windings between at least two different voltage levels.

In an embodiment, an electronic device includes an integrated circuit package, a semiconductor die housed in the integrated circuit package, and a coupled inductor housed in the integrated circuit package and electrically coupled to the semiconductor die. The coupled inductor includes a magnetic core having opposing first and second sides, and a linear separation distance between the first and second sides defines a length of the magnetic core. The coupled inductor further includes N windings passing at least partially through the magnetic core in the lengthwise direction, where N is an integer greater than one. Each of the N windings forms a loop in the magnetic core around a respective winding axis, and each winding axis is generally perpendicular to the lengthwise direction and parallel to but offset from each other winding axis. Each winding has opposing first and second ends extending toward at least the first and second sides of the magnetic core, respectively.

### BRIEF DESCRIPTION OF THE DRAWINGS

FIG. 1 shows a perspective view of a coupled inductor array, according to an embodiment.

FIG. 2 shows a perspective view of the FIG. 1 coupled inductor array with its magnetic core shown as transparent.

FIG. 3 shows a top plan view of the FIG. 1 coupled inductor array with a top plate removed.

FIG. 4 shows a top plan view of an alternate embodiment of the FIG. 1 coupled inductor array with a top plate removed and with longer winding loops than the FIG. 3 embodiment.

FIG. 5 shows a top plan view of an alternate embodiment of the FIG. 1 coupled inductor array with a top plate removed and with smaller winding loops than the FIG. 3 embodiment.

FIG. 6 shows a top plan view of an alternate embodiment of the FIG. 1 coupled inductor array with a top plate removed and with circular winding loops.

FIG. 7 shows a cross-sectional view of the FIG. 1 coupled inductor array.

FIG. 8 shows a cross-sectional view of an alternate embodiment of the FIG. 1 coupled inductor array including coupling teeth.

FIG. 9 shows a cross-sectional view of an alternate embodiment of the FIG. 1 coupled inductor array including both leakage and coupling teeth.

FIG. 10 shows a cross-sectional view of another alternate embodiment of the FIG. 1 coupled inductor array including both leakage and coupling teeth.

FIG. 11 shows a cross-sectional view of an alternate embodiment of the FIG. 1 coupled inductor array including leakage teeth, coupling teeth, and a non-magnetic spacer separating the coupling teeth from the top plate.

FIG. 12 shows a schematic of a three-phase buck converter including the coupled inductor array of FIG. 1, according to an embodiment.

FIG. 13 shows one possible printed circuit board footprint for use with the coupled inductor array of FIG. 1 in a multi-phase buck converter application, according to an embodiment.

FIG. 14 shows a perspective view of a coupled inductor array similar to that of FIG. 1, but where winding second ends electrically couple to a common tab, according to an embodiment.

FIG. 15 shows one possible printed circuit board footprint for use with the coupled inductor array of FIG. 14 in a multi-phase buck converter application, according to an embodiment.

FIG. 16 shows a perspective view of a coupled inductor array similar to that of FIG. 1, but where the windings are wire windings having substantially round cross-section, according to an embodiment.

FIG. 17 shows one possible printed circuit board footprint for use with the coupled inductor array of FIG. 16 in a multi-phase buck converter application, according to an embodiment.

FIG. 18 shows a perspective view of a coupled inductor array similar to that of FIG. 16, but where winding ends extend from opposing core sides, according to an embodiment.

FIG. 19 shows one possible printed circuit board footprint for use with the coupled inductor array of FIG. 18 in a multi-phase buck converter application, according to an embodiment.

FIG. 20 shows a perspective view of a two-winding coupled inductor array, according to an embodiment.

FIG. 21 shows a top plan view of an alternate embodiment of the FIG. 20 coupled inductor array with a top plate removed and with circular winding loops.

FIG. 22 shows a top plan view of an alternate embodiment of the FIG. 20 coupled inductor array with a top plate removed and with windings formed of conductive film.

FIG. 23 shows a perspective view of a coupled inductor array similar to that of FIG. 1, but with solder tabs on both its top and bottom surfaces, according to an embodiment.

### DETAILED DESCRIPTION OF THE EMBODIMENTS

Disclosed herein are coupled inductor arrays that may be used, for example, as energy storage inductors in a multi-phase switching power converter. Such coupled inductors may realize one or more significant advantages, as discussed below. For example, certain embodiments of these inductors achieve relatively strong magnetic coupling, relatively large leakage inductance values and/or relatively low core losses in a small package size. As another example, leakage and/or magnetizing inductance is readily adjustable during the design and/or manufacture of certain embodiments. In the following disclosure, specific instances of an item may be referred to by use of a numeral in parentheses (e.g., winding 118(1)) while numerals without parentheses refer to any such item (e.g., windings 118).

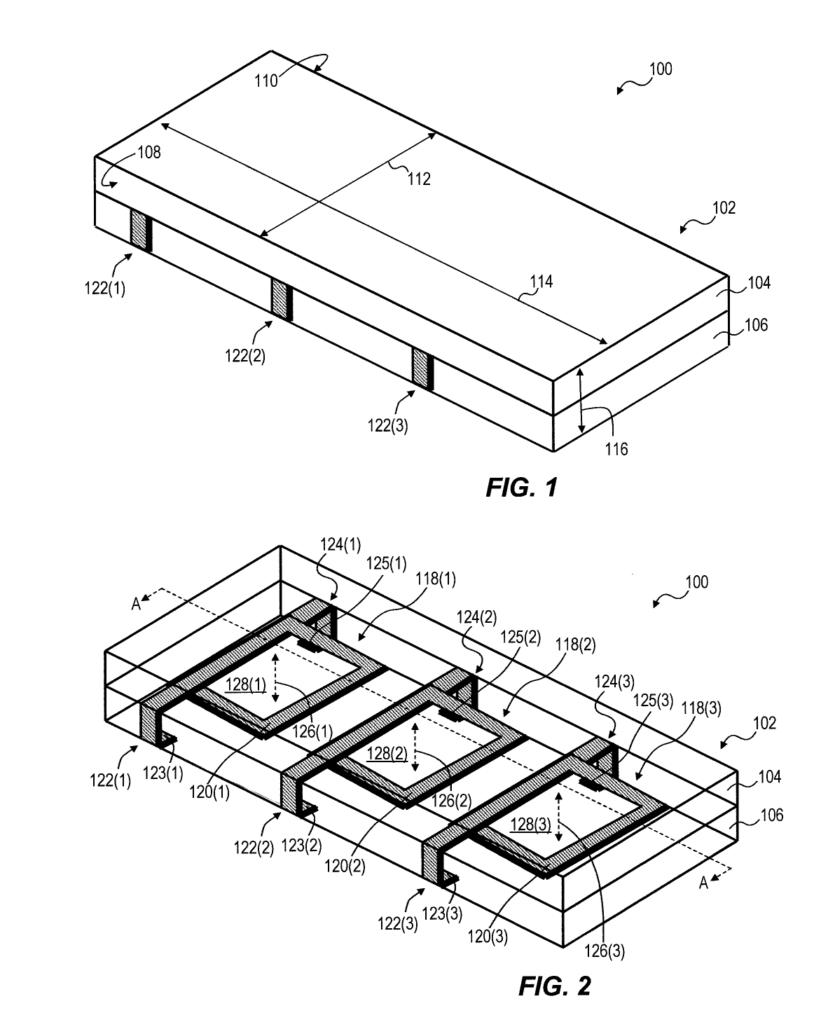

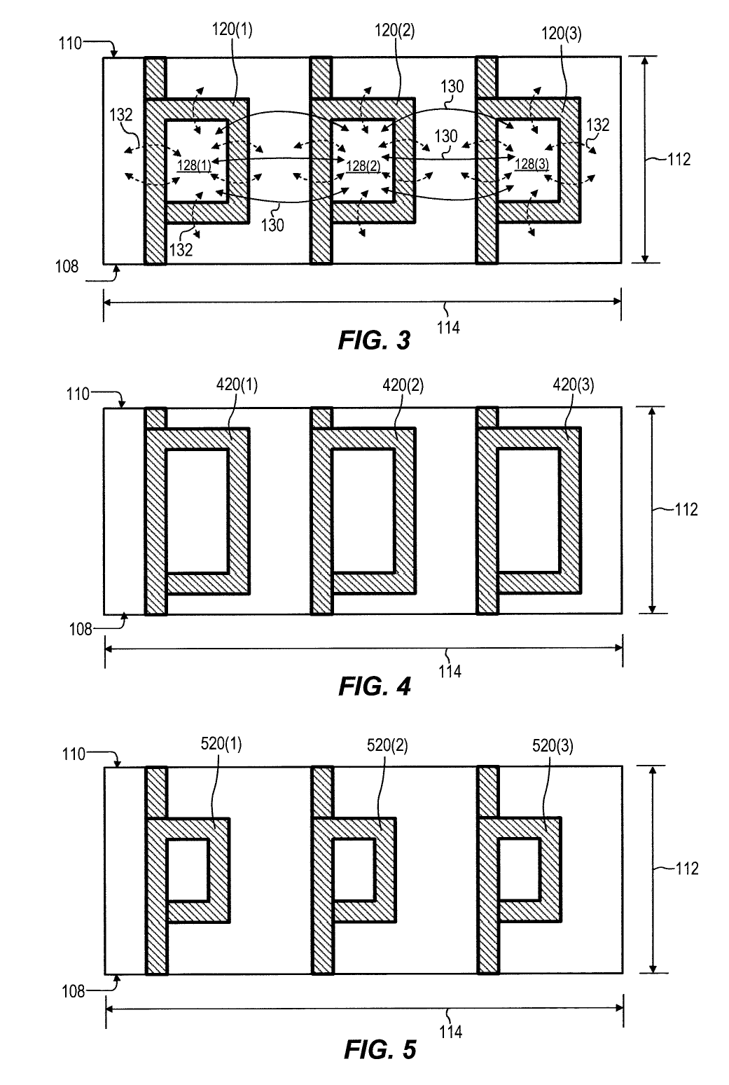

FIG. 1 shows a perspective view of a coupled inductor array 100. Array 100 includes a magnetic core 102 formed of a magnetic material, such as a ferrite material, a powder iron material within a binder, or a number of layers of magnetic film. Magnetic core 102 includes a top plate 104 disposed on a bottom plate 106 and has opposing first and second sides 108, 110 separated by a linear separation distance defining a core length 112. Magnetic core 102 also has a width 114 perpendicular to length 112, as well as a height 116 perpendicular to both length 112 and width 114. FIG. 2 shows array 100 with magnetic core 102 shown as transparent. FIG. 3 shows a top plan view of array 100 with top plate 104 removed.

Coupled inductor array 100 further includes two or more windings 118 disposed in magnetic core 102 between top and bottom plates 104, 106. While the figures of the present disclosure show array 100 as having three windings 118, it should be understood that such arrays could be modified to have any number of windings greater than one. In order words, the coupled inductor arrays disclosed herein could be adapted to have N windings, where N is any integer greater than one.

Each winding 118 passes through magnetic core 102 in the lengthwise 112 direction and forms a loop 120 in magnetic core 102. Loops 120 are generally planar in typical embodiments. Although loops 120 are shown as forming a single turn, they may alternately form two or more turns to promote low magnetic flux density and associated low core losses. Opposing first and second ends 122, 124 of windings 118 extend towards core first and second sides 108, 110, respectively. Each first end 122 forms a respective first solder tab 123, and each second end 124 forms a respective second solder tab 125. Solder tabs 123, 125 are configured for surface mount attachment to a printed circuit board (PCB).

Each loop 120 is wound around a respective winding axis 126, and each winding axis 126 is generally parallel to but offset from each other winding axis 126 in the widthwise 114 direction. Accordingly, each loop encloses a respective area 128 within magnetic core 102, and each loop area 128 is non-overlapping with each other loop area 128 along the core's width 114. Such configuration causes coupled inductor array 100 to have “negative” or “inverse” magnetic coupling. Inverse magnetic coupling is characterized in array 100, for example, by current of increasing magnitude flowing through one of windings 118 in a first direction inducing current of increasing magnitude flowing through the remaining windings 118 in the first direction. For example, current of increasing magnitude flowing into winding 118(2) from core first side 108 will induce current of increasing magnitude flowing into windings 118(1), 118(3) from core first side 108.

Array 100's configuration promotes large magnetizing and leakage inductance values and low-reluctance magnetic flux paths. In particular, windings 118 are typically longer in the lengthwise 112 direction than in the widthwise 114 direction, resulting in large portions of windings 118 being immediately adjacent and providing wide paths for magnetic flux coupling adjacent windings. Magnetic flux coupling adjacent windings is represented by solid-line arrows 130 in FIG. 3, only some of which are labeled for illustrative clarity. Such wide paths provide a low reluctance path for magnetizing flux, thereby promoting strong magnetic coupling between windings and low core losses.

Additionally, magnetic core 102 typically extends beyond loops 120, such that each loop area 128 is smaller than an area of magnetic core 102 in the same plane as the loop. Consequentially, magnetic core 102 provides paths for leakage magnetic flux around much or all of each loop 120's perimeter, where leakage magnetic flux is magnetic flux generated by changing current through one winding 118 that does not couple the remaining windings 118. Leakage magnetic flux is represented by dashed-line arrows 132 in FIG. 3, only some of which are labeled for illustrative clarity. Consequentially, each winding 118 has a relatively wide, low reluctance leakage flux path, thereby promoting low core losses and large leakage inductance values associated with windings 118.

Magnetizing inductance and leakage inductance can be independently controlled during the design and/or manufacture of coupled inductor array 100 by controlling the size and/or shape of windings 118, and/or the extent to which magnetic core 102 extends beyond winding loops 120. In particular, magnetizing inductance can be increased by increasing the portions of windings 118 that are immediately adjacent and/or by decreasing the spacing between windings 118. For example, FIG. 4 shows a top plan view analogous to FIG. 3, but of an alternative embodiment including winding loops 420 in place of winding loops 120. Winding loops 420 are longer in lengthwise direction 112 than winding loops 120 of the FIG. 3 embodiment. Accordingly, the FIG. 4 embodiment will have a larger magnetizing inductance than the FIG. 3 embodiment, assuming all else is equal. However, the relatively long length of winding loops 420 reduces the portion of magnetic core 102 available for coupling leakage magnetic flux. Thus, the FIG. 4 embodiment will have smaller leakage inductance values than the FIG. 3 embodiment, assuming all else is equal.

As another example, FIG. 5 shows a cross-sectional view analogous to FIG. 3, but of an alternate embodiment including winding loops 520 in place of winding loops 120. Winding loops 520 are smaller than winding loops 120 of the FIG. 3 embodiment. Thus, a greater portion of magnetic core 102 is outside of winding loops in the FIG. 5 embodiment than in the FIG. 3 embodiment, resulting in a larger portion of the core being available for leakage magnetic flux in the FIG. 5 embodiment. Thus, the FIG. 5 embodiment will have larger leakage inductance values than the FIG. 3 embodiment, assuming all else is equal. However, a smaller portion of the winding loops are immediately adjacent in the FIG. 5 embodiment than in the FIG. 3 embodiment. Thus, the FIG. 5 embodiment will have a smaller magnetizing inductance than the FIG. 3 embodiment, assuming all else is equal.

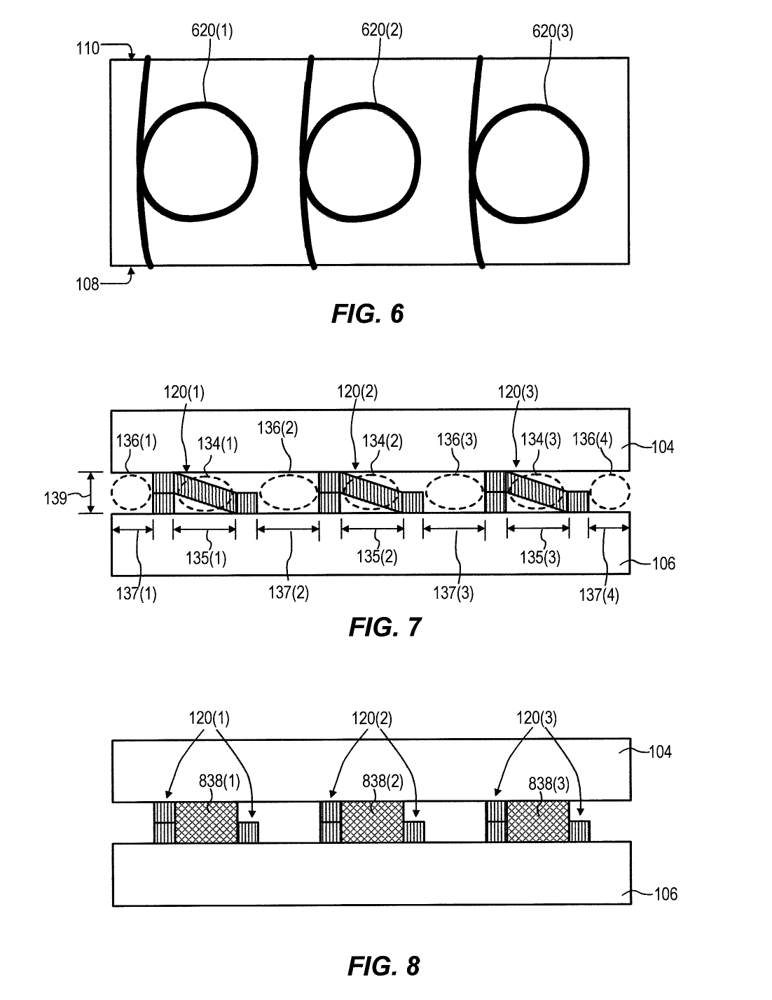

The embodiments discussed above have rectangular shaped winding loops, which help maximize portions of the loops that are immediately adjacent, thereby promoting large magnetizing inductance values. However, winding loops can have other shapes. For example, FIG. 6 shows a cross-sectional view analogous to FIG. 3, but of an alternate embodiment including circular winding loops 620 in place of rectangular winding loops 120. The circular shape reduces loop length, thereby promoting low winding resistance. However, the circular shape also reduces portions of winding loops 620 that are immediately adjacent, thereby reducing magnetizing inductance.

Magnetic core 102's configuration can also be varied during the design and/or manufacture of coupled inductor array 100 to control magnetizing and/or leakage inductance. FIG. 7 shows a cross-sectional view of coupled inductor array 100 taken along line segment A-A of FIG. 2. Portions 134 within winding loops 120 provide paths for both magnetic flux coupling windings 118 and leakage magnetic flux, while portions 136 outside of winding loops 120 provide paths for leakage magnetic flux only. Magnetizing inductance and leakage inductance are both roughly proportional to cross-sectional area of portions 134, and leakage inductance is also roughly proportional to cross-sectional area of portions 136. Thus, magnetizing and leakage inductance can be adjusted, for example, by adjusting widths 135 of portions 134, and leakage inductance can be independently adjusted, for example, by adjusting widths 137 of portions 136. Each instance of width 135 need not necessarily be the same, and each instance of width 137 also need not necessarily be the same. For example, in some embodiments, one portion 136 has a larger width 137 than other portions 136 to create asymmetrical leakage inductance values.

Magnetizing and leakage inductance can also be varied together by changing spacing 139 between top and bottom plates 104, 106. In general, the smaller spacing 139, the greater the magnetizing and leakage inductance.

Additionally, magnetizing inductance and/or leakage inductance can be controlled by controlling the reluctance of portions 134 and/or 136. For example, magnetizing and leakage inductance can be increased by adding magnetic material to portions 134 to decrease reluctance of the magnetic flux paths coupling windings 118 and the leakage magnetic flux paths. Similarly, leakage inductance can be increased by adding magnetic material to portions 136 to decrease reluctance of the leakage magnetic flux paths.

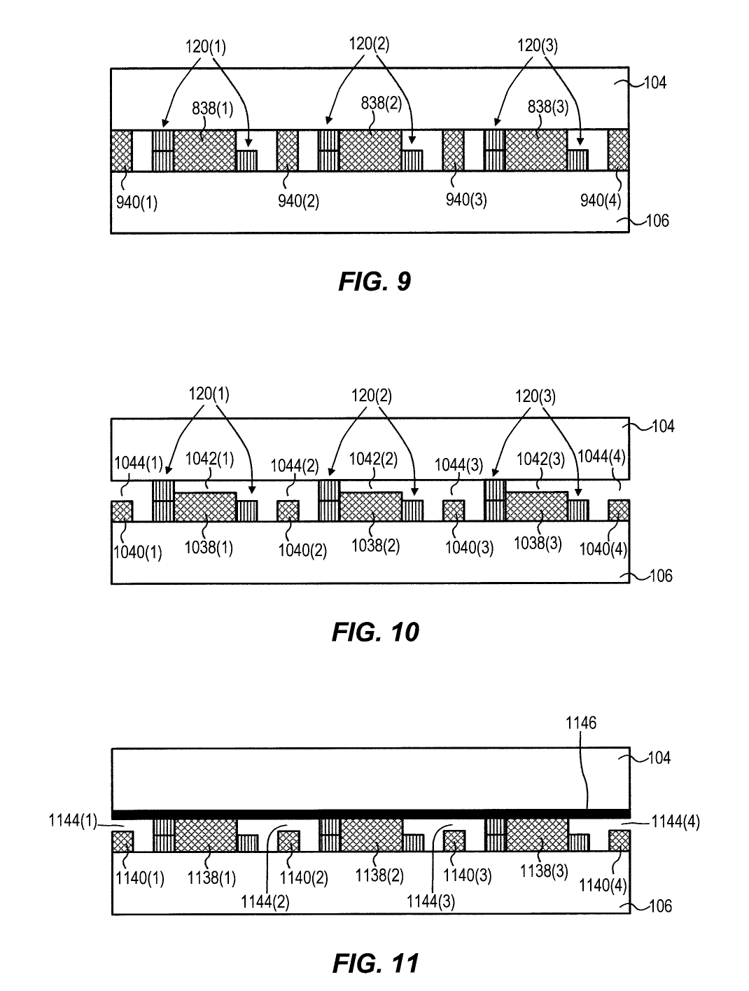

FIG. 8 shows a cross-sectional view analogous to FIG. 7, but of an alternate embodiment including coupling teeth 838 disposed between top and bottom plates 104, 106 in portions 134 within winding loops 120. Coupling teeth 838, which are formed of a magnetic material, reduce reluctance of the magnetic flux paths in portions 134, thereby increasing magnetizing and leakage inductance. As another example, FIG. 9 shows a cross-sectional view analogous to FIG. 7, but of an alternate embodiment including coupling teeth 838 in portions 134 and leakage teeth 940 disposed between top and bottom plates 104, 106 in portions 136. Leakage teeth 940, which are also formed of a magnetic material, reduce the reluctance of the magnetic flux paths in portions 136, thereby increasing leakage inductance values. Each of leakage teeth 940(2), 940(3) are disposed between adjacent winding loops, while leakage teeth 940(1), 940(4) are respectively disposed at opposing ends of the row of winding loops. The magnetic materials forming coupling teeth 838 and leakage teeth 940 need not be the same and can be individually selected to achieve desired magnetizing and leakage inductance values. For example, in certain embodiments, coupling teeth 838 are formed of a material having a higher magnetic permeability than leakage teeth 940. Coupling teeth 838 and leakage teeth 940 can alternately be formed of the same magnetic material to simplify core 102 construction, and both teeth can even be formed of the same material as top and bottom plates 104, 106 to further simplify core construction. In some embodiments, the magnetic materials forming coupling teeth 838 and/or winding teeth 940 are non-homogenous.

One or more of coupling teeth 838 may be separated from top and/or bottom plate 104, 106 by a gap filled with non-magnetic material, to control magnetizing and leakage inductance and/or to help prevent magnetic saturation. Such gaps are filled, for example, with air, plastic, paper, and/or adhesive. Similarly, one or more of leakage teeth 940 may be separated from top and/or bottom plate 104, 106 by a gap filled with non-magnetic material, such as air, plastic, paper, and/or adhesive, to control leakage inductance. For example, FIG. 10 shows a cross-sectional view analogous to FIG. 7, but of an alternate embodiment including coupling teeth 1038 separated from top plate 104 by air gaps 1042. The FIG. 10 embodiment further includes leakage teeth 1040 separated from top plate 104 by air gaps 1044. Thicknesses of air gaps 1042 and 1044 are optionally individually optimized and need not be the same. As another example, FIG. 11 shows a cross-sectional view analogous to FIG. 7, but of an alternate embodiment where each coupling tooth 1138 is separated from top plate 104 by a spacer 1146 formed of non-magnetic material, and each leakage tooth 1140 is separated from top plate 104 by a respective air gap 1144 as well as spacer 1146. In certain embodiments, spacer 1146 is formed of the same material as an insulator (not shown) separating overlapping portions of windings 118.

In certain embodiments, magnetic core 102 is formed of material having a distributed air gap, such as powder iron within a binder. In such embodiments, leakage inductance and/or magnetizing inductance can be also be adjusted by varying the material composition to change the distributed air gap properties.

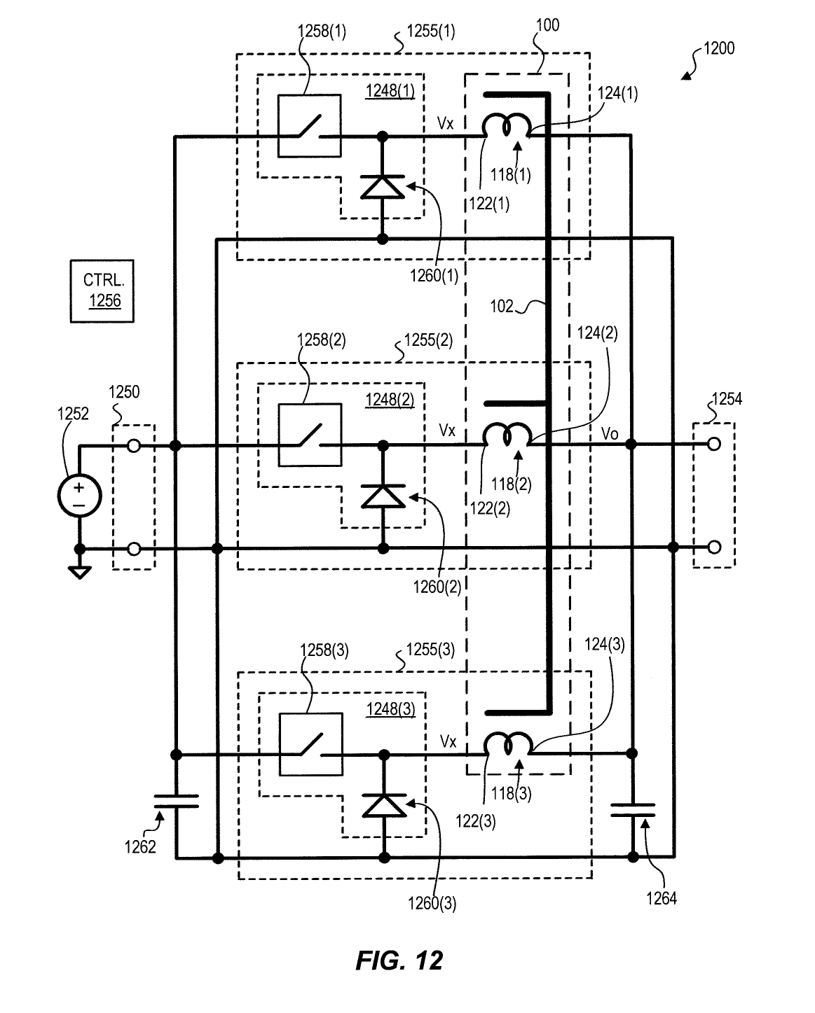

One possible application of coupled inductor array 100 is in switching power converter applications, including but not limited to multi-phase buck converters, multi-phase boost converters, or multi-phase buck-boost converters. For example, FIG. 12 shows one possible use of coupled inductor array 100 in multi-phase buck converter. In particular, FIG. 12 shows a schematic of a three-phase buck converter 1200, which uses coupled inductor array 100 as a coupled inductor. Each winding first end 122 is electrically coupled to a respective switching node Vx, and each winding second end 124 is electrically coupled to a common output node Vo. A respective switching circuit 1248 is electrically coupled to each switching node Vx. Each switching circuit 1248 is electrically coupled to an input port 1250, which is in turn electrically coupled to an electric power source 1252. An output port 1254 is electrically coupled to output node Vo. Each switching circuit 1248 and respective inductor is collectively referred to as a “phase” 1255 of the converter. Thus, multi-phase buck converter 1200 is a three-phase converter.

A controller 1256 causes each switching circuit 1248 to repeatedly switch its respective winding first end 122 between electric power source 1252 and ground, thereby switching its first end between two different voltage levels, to transfer power from electric power source 1252 to a load (not shown) electrically coupled across output port 1254. Controller 1256 typically causes switching circuit 1248 to switch at a relatively high frequency, such as at 100 kilohertz or greater, to promote low ripple current magnitude and fast transient response, as well as to ensure that switching induced noise is at a frequency above that perceivable by humans.

Each switching circuit 1248 includes a control switching device 1258 that alternately switches between its conductive and non-conductive states under the command of controller 1256. Each switching circuit 1248 further includes a freewheeling device 1260 adapted to provide a path for current through its respective winding 118 when the control switching device 1258 of the switching circuit transitions from its conductive to non-conductive state. Freewheeling devices 1260 may be diodes, as shown, to promote system simplicity. However, in certain alternate embodiments, freewheeling devices 1260 may be supplemented by or replaced with a switching device operating under the command of controller 1256 to improve converter performance. For example, diodes in freewheeling devices 1260 may be supplemented by switching devices to reduce freewheeling device 1260 forward voltage drop. In the context of this disclosure, a switching device includes, but is not limited to, a bipolar junction transistor, a field effect transistor (e.g., a N-channel or P-channel metal oxide semiconductor field effect transistor, a junction field effect transistor, a metal semiconductor field effect transistor), an insulated gate bipolar junction transistor, a thyristor, or a silicon controlled rectifier.

Controller 1256 is optionally configured to control switching circuits 1248 to regulate one or more parameters of multi-phase buck converter 1200, such as input voltage, input current, input power, output voltage, output current, or output power. Buck converter 1200 typically includes one or more input capacitors 1262 electrically coupled across input port 1254 for providing a ripple component of switching circuit 1248 input current. Additionally, one or more output capacitors 1264 are generally electrically coupled across output port 1254 to shunt ripple current generated by switching circuits 1248.

Buck converter 1200 could be modified to have a different number of phases, and coupled inductor array 100 could be modified accordingly to have a corresponding number of windings 118. Additionally, buck converter 1200 could be modified to incorporate two or more instances of coupled inductor array 100. For example, one alternate embodiment of converter 1200 includes six phases 1255 and two instances of coupled inductor array 100. A first instance of array 100 serves the first through third phases, and a second instance of array 100 serves the fourth through sixth phases. Buck converter 1200 could also be modified to have a different topology, such as that of a multi-phase boost converter or a multi-phase buck-boost converter, or an isolated topology, such as a flyback or forward converter.

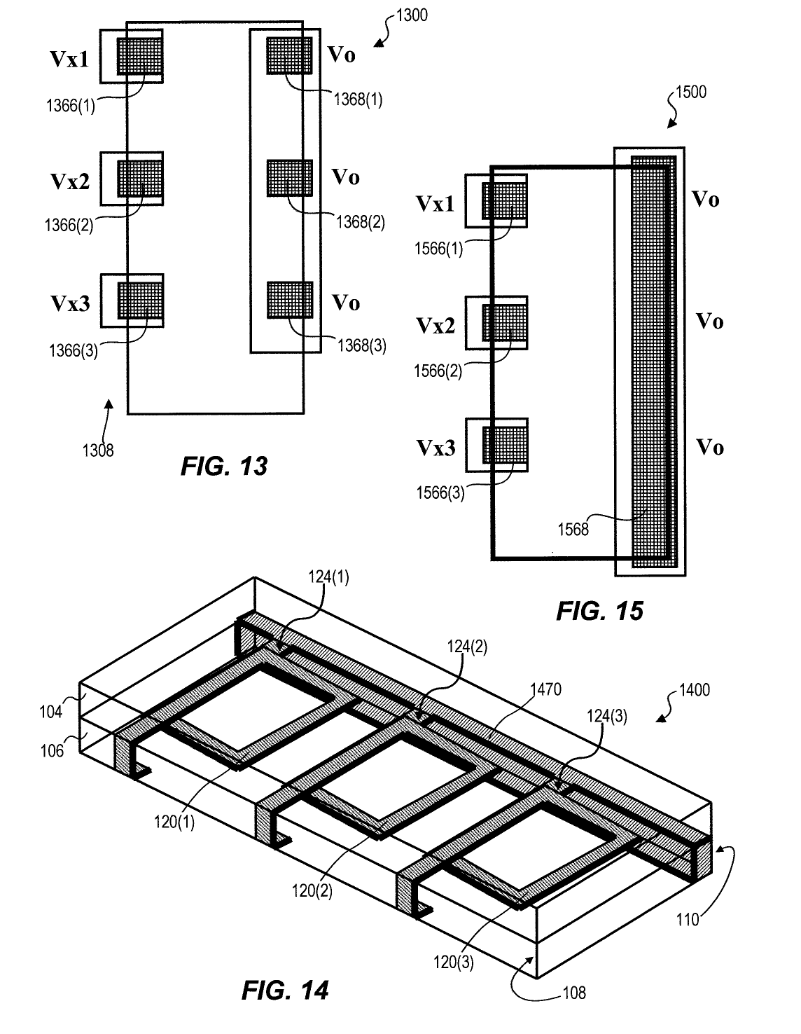

FIG. 13 shows a printed circuit board (PCB) footprint 1300, which is one possible footprint for use with coupled inductor array 100 in a multi-phase buck converter application, such as buck converter 1200 (FIG. 12). Footprint 1300 includes pads 1366 for coupling each first solder tab 123 to a respective switching node Vx, as well as pads 1368 for coupling each second solder tab 125 to a common output node Vo. Due to array 100's inverse magnetic coupling, all switching nodes Vx are on a first side 1308 of footprint 1300, which promotes layout simplicity in a PCB including footprint 1300.

In certain alternate embodiments, each winding second end 124 is electrically coupled to a common conductor, such as a common tab to provide a low impedance connection to external circuitry. For example, FIG. 14 shows a perspective view of a coupled inductor array 1400, which is the same as array 100 (FIG. 1), but where winding second ends 124 electrically couple to a common tab 1470 instead of forming respective solder tabs. Tab 1470 is, for example, configured for surface mount attachment to a printed circuit board. FIG. 15 shows a PCB footprint 1500, which is one possible footprint for use with coupled inductor array 1400 in a multi-phase buck converter application, such as buck converter 1200 (FIG. 12). Footprint 1500 includes pads 1566 for coupling each first solder tab 123 to a respective switching node Vx, as well as pad 1568 for coupling common tab 1470 to a common output node Vo. It can be appreciated from FIG. 15 that common tab 1470 provides a large surface area for connecting to a PCB pad, thereby promoting a low impedance connection between the tab and a PCB and helping cool inductor 1400 as well as nearby components.

Although magnetic core 102 is shown as including discrete top and bottom plates 104, 106, core 102 can have other configurations. For example, top and bottom plates 104, 106 could alternately be part of a single piece magnetic element, optionally including coupling teeth 838 and/or leakage teeth 940. As another example, in some alternate embodiments, magnetic core 102 is a single piece monolithic structure with windings 118 embedded therein, such as a core formed by molding a composition including magnetic material in a binder. In such embodiments, there is no gap or separation between core sections, and magnetizing and leakage inductance can be varied by varying the magnetic material composition and/or the winding configuration, as discussed above. As yet another example, in certain alternate embodiments, magnetic core 102 is formed by disposing a plurality of layers or films of magnetic material. In such embodiments, a non-magnetic material is optionally disposed in at least part of portions 134 and/or 136 to create gaps analogous to gaps 1042, 1044 in FIG. 10. Additionally, in some alternate embodiments, magnetic core 102 completely surrounds winding loops 120. In embodiments including coupling teeth 838 and/or leakage teeth 940, such teeth could be discrete magnetic elements and/or part of another piece of magnetic core 102. For example, in some embodiments, at least one of coupling teeth 838 and/or leakage teeth 940 are part of top plate 104 or bottom plate 106.

Windings 118 are, for example, formed separately from core 102 and subsequently disposed in the core, such as before joining top and bottom plates 104, 106. In embodiments where core 102 is formed by molding a composition including magnetic material in a binder, windings 118 are, for example, separately formed and placed in a mold prior to adding the composition to the mold. Windings 108 could also be formed by applying a conductive film to a portion of magnetic core 102 or a substrate disposed on magnetic core 102, such as by applying a thick-film conductive material such as silver. An insulating film may be disposed between adjacent conductive film layers to prevent different portions of windings 118 from shorting together. In embodiments where one or more of windings 108 are multi-turn windings, magnetic material optionally separates two or more winding turns from each other to provided additional paths for leakage magnetic flux, thereby promoting large leakage inductance values.

Arrays 100 and 1400 are shown with windings 118 being foil windings. The rectangular cross section of foil windings helps reduce skin effect induced losses, therefore promoting low winding resistance at high frequencies. However, the coupled inductor arrays disclosed herein are not limited to foil windings. For example, windings 118 could alternately have round or square cross-section, or could alternately be cables formed of multiple conductors. Additionally, while arrays 100 and 1400 are shown as including solder tabs configured for surface mount attachment to a PCB, the coupled inductor arrays disclosed herein could be modified to connect to external circuitry in other manners, such as by using through-hole connections or by coupling to a socket.

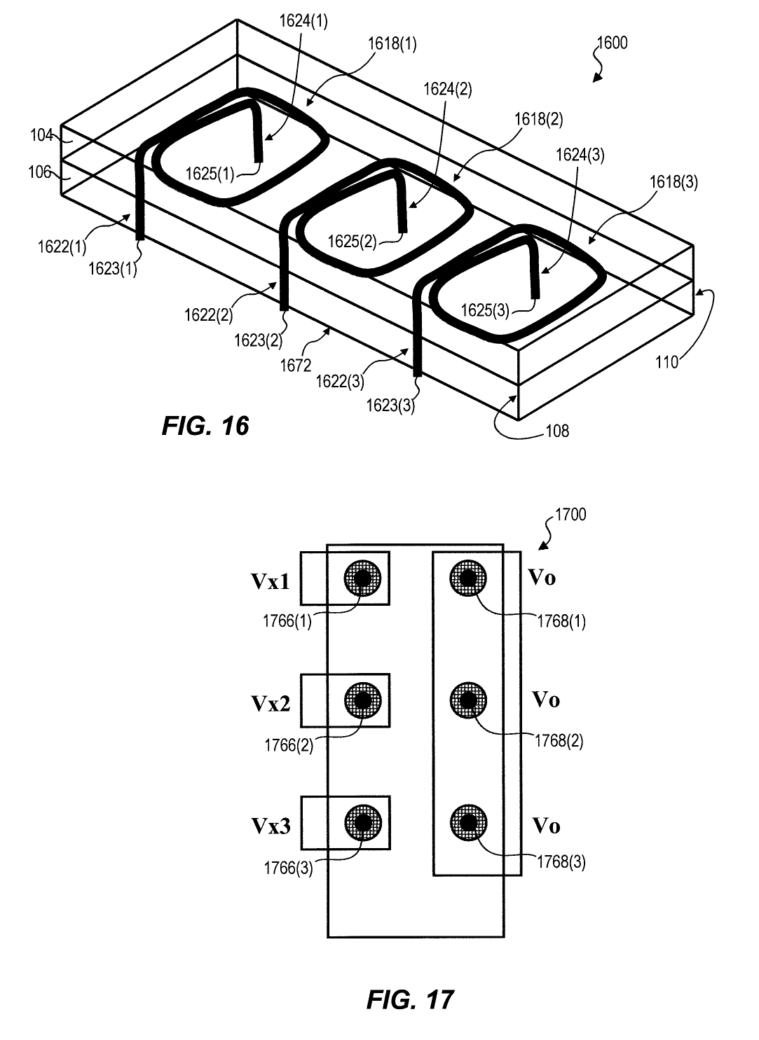

For example, FIG. 16 shows a perspective view of a coupled inductor array 1600, which is similar to coupled inductor 100 (FIG. 1), but where foil windings 118 are replaced with wire windings 1618 having substantially round cross-section. Magnetic core 102 is shown as transparent in FIG. 16 to show windings 1618. Opposing first and second ends 1622, 1624 of windings 1618 respectively faun first and second through-hold pins 1623, 1625 extending through a bottom surface 1672 of magnetic core 102. FIG. 17 shows a PCB footprint 1700, which is one possible footprint for use with coupled inductor array 1600 in a multi-phase buck converter application, such as buck converter 1200 (FIG. 12). Footprint 1700 includes through-holes 1766 for coupling each through-hole pin 1623 to a respective switching node Vx, as well as through-holes 1768 for coupling through-hole pins 1625 to a common output node Vo.

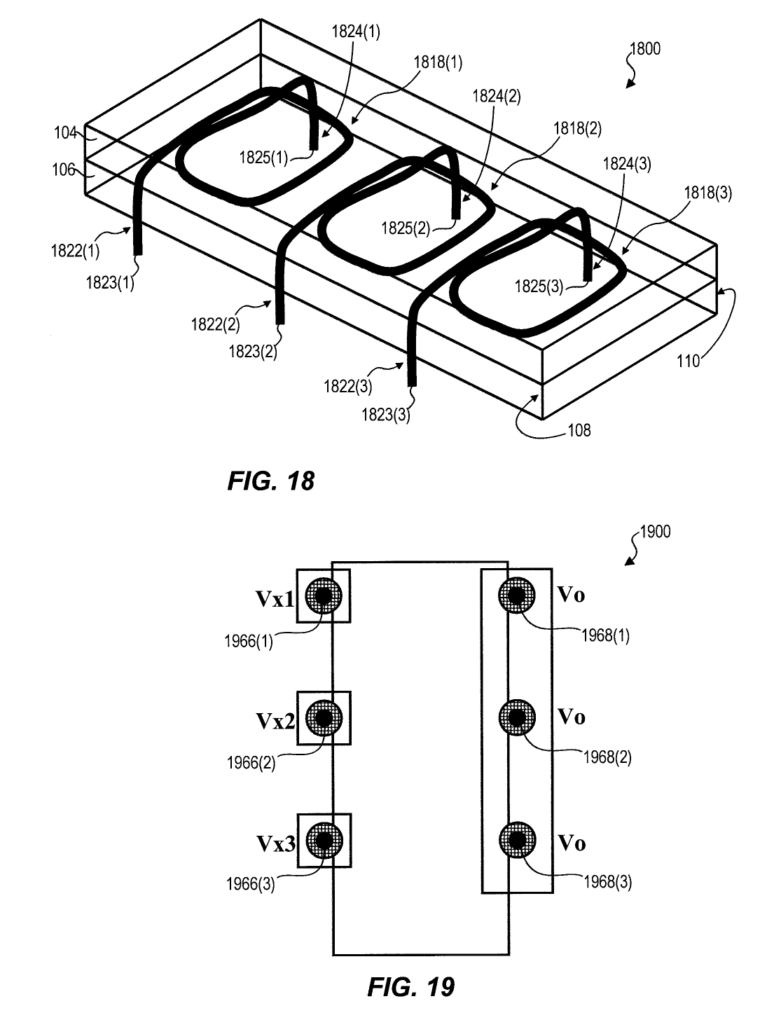

As another example, FIG. 18 shows a perspective view of a coupled inductor array 1800, which is similar to coupled inductor array 1600 (FIG. 16), but includes wire windings 1818 having opposing first and second ends 1822, 1824 extending from core sides 108, 110, respectively, to form first and second through-hole pins 1823, 1825. FIG. 19 shows a PCB footprint 1900, which is one possible footprint for use with coupled inductor array 1800 in a multi-phase buck converter application, such as buck converter 1200 (FIG. 12). Footprint 1900 includes through-holes 1966 for coupling each through-hole pin 1823 to a respective switching node Vx, as well as through-holes 1968 for coupling through-hole pins 1825 to a common output node Vo. Array 1800 will typically be not as mechanically robust as array 1600 (FIG. 16) due to array 1800's windings extending from magnetic core 102's sides instead of from magnetic core 102's bottom. However, the fact that through-hole pins 1823, 1825 extend from magnetic core sides 108, 110 may eliminate the need to route PCB conductive traces under magnetic core 102, thereby shortening trace length. Shortening trace length, in turn, reduces trace impedance and associated losses.

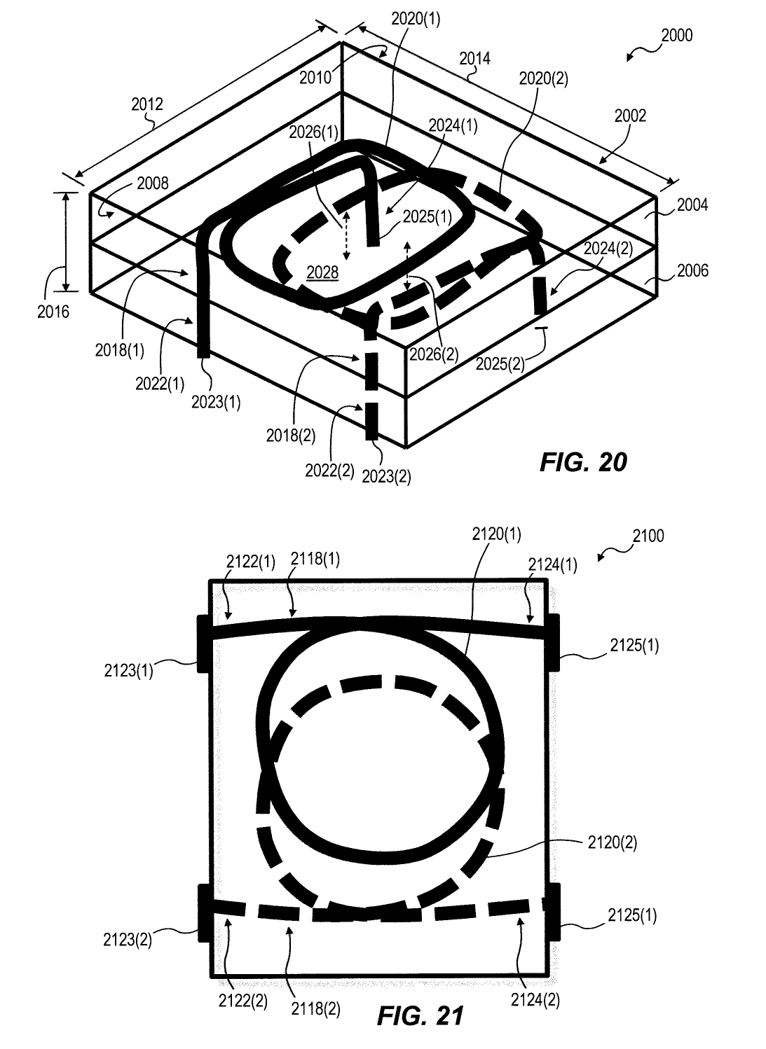

In embodiments having only two windings, the winding loops may at least partially overlap, thereby helping minimize inductor footprint size. For example, FIG. 20 shows a perspective view of a two-winding coupled inductor array 2000 including partially overlapping winding loops. Coupled inductor array 2000 includes a magnetic core 2002 including top and bottom plates 2004, 2006. Magnetic core 2002 has opposing first and second sides 2008, 2010 separated by a linear separation distance defining a core length 2012. Magnetic core 2002 also has a width 2014 perpendicular to length 2012, as well as a height 2016 perpendicular to both length 2012 and width 2014. Magnetic core 2002 is shown as transparent in FIG. 20.

Coupled inductor array 2000 further includes two windings 2018 disposed in magnetic core 2002 between top and bottom plates 2004, 2006. Although winding 2018(2) is shown by a dashed line to help a viewer distinguish between windings 2018(1), 2018(2), in actuality, both windings typically have the same configuration. Each winding 2018 passes through magnetic core 2002 in the lengthwise 2012 direction and forms a loop 2020 in magnetic core 2002. Loops 2020 are generally planar in typical embodiments. Although loops 2020 are shown as forming a single turn, they may alternately form two or more turns to promote low magnetic flux density and associated low core losses. Opposing first and second ends 2022, 2024 of windings 2018 extend towards core first and second sides 2008, 2010, respectively. Each first end 2022 forms a respective first through-hole pin 2023, and each second end 2024 fauns a respective second through-hole pin 2025. In certain alternate embodiments, winding ends 2022, 2024 are adapted to connect to external circuitry in other manners. For example, winding ends 2022, 2024 form respective solder tabs configured for surface mount attachment to a PCB in some alternate embodiments.

Each loop 2020 is wound around a respective winding axis 2026. Loops 2020 are wound in opposing directions to achieve inverse magnetic coupling. Such inverse magnetic coupling is characterized in array 2000, for example, by current of increasing magnitude flowing into winding 2018(1) from core first side 2008 inducing a current of increasing magnitude flowing into winding 2018(2) from core first side 2008. Each winding axis 2026 is generally parallel to but offset from each other winding axis 2026 in the widthwise 2014 direction. Both loops 2020 are partially overlapping so that the two loops enclose a common area 2028 within magnetic core 2020. Magnetizing and leakage inductance values can be adjusted during coupled inductor array 2000 design and/or manufacture by adjusting the extent to which winding loops 2020 overlap, or in other words, by adjusting the size of area 2028 enclosed by both loops. In particular, leakage inductance will increase and magnetizing inductance will decrease as winding loops 2020 are separated from each other so that area 2028 size decreases. Conversely, leakage inductance will decrease and magnetizing inductance will increase as winding loops 2020 are brought closer together so that area 2028 size increases.

Leakage inductance and/or magnetizing inductance can also be adjusted during inductor design and/or manufacture by adding one or more coupling teeth and/or one or more leakage teeth in a manner similar to that discussed above with respect to FIGS. 8-11. For example, magnetizing and leakage inductance could be increased by adding a leakage tooth connecting top and bottom plates 2004, 2006 in area 2028 enclosed by both winding loops 2020. As another example, leakage inductance could be increased by adding a coupling tooth connecting top and bottom plates 2004, 2006 outside of area 2028. Leakage inductance and/or magnetizing inductance could also be varied during array design and/or manufacture by using techniques similar to those discussed above with respect to array 100, such as by varying winding loop 2020 size, winding loop 2020 geometry, magnetic core 2002 composition, and/or spacing between top and bottom plates 2004, 2006.

For example, FIG. 21 shows a top plan view of a coupled inductor array 2100 with its top plate removed. Array 2100 is similar to array 2000 of FIG. 20 but with winding loops 2120 having substantially circular shape instead of substantially rectangular shape. The circular shape helps reduce winding 2118 length, thereby reducing winding impedance. However, the circular shape reduces the portion of winding loops 2100 that overlap, thereby decreasing magnetizing inductance and increasing leakage inductance. While winding 2118(2) is shown as a dashed line to help a viewer distinguish between windings 2118(1) and 2118(2), in actuality, both windings typically have the same configuration. Array 2100 also differs from array 2000 in that opposing winding ends 2122, 2124 are electrically coupled to respective solder tabs 2123, 2125, instead of forming through-hole pins.

The configuration of magnetic core 2002 (FIG. 20) can be varied in manners similar to that discussed above with respect to array 1000. For example, top and bottom plates 2004, 2006 could alternately be part of a single piece magnetic element. As another example, in some alternate embodiments, magnetic core 2002 is a single piece monolithic structure with windings 2018 embedded therein, such as a core formed by molding a composition including magnetic material in a binder. As yet another example, in certain alternate embodiments, magnetic core 2002 is formed by disposing a plurality of layers or films of magnetic material. Additionally, in some alternate embodiments, magnetic core 2002 completely surrounds winding loops 2020.

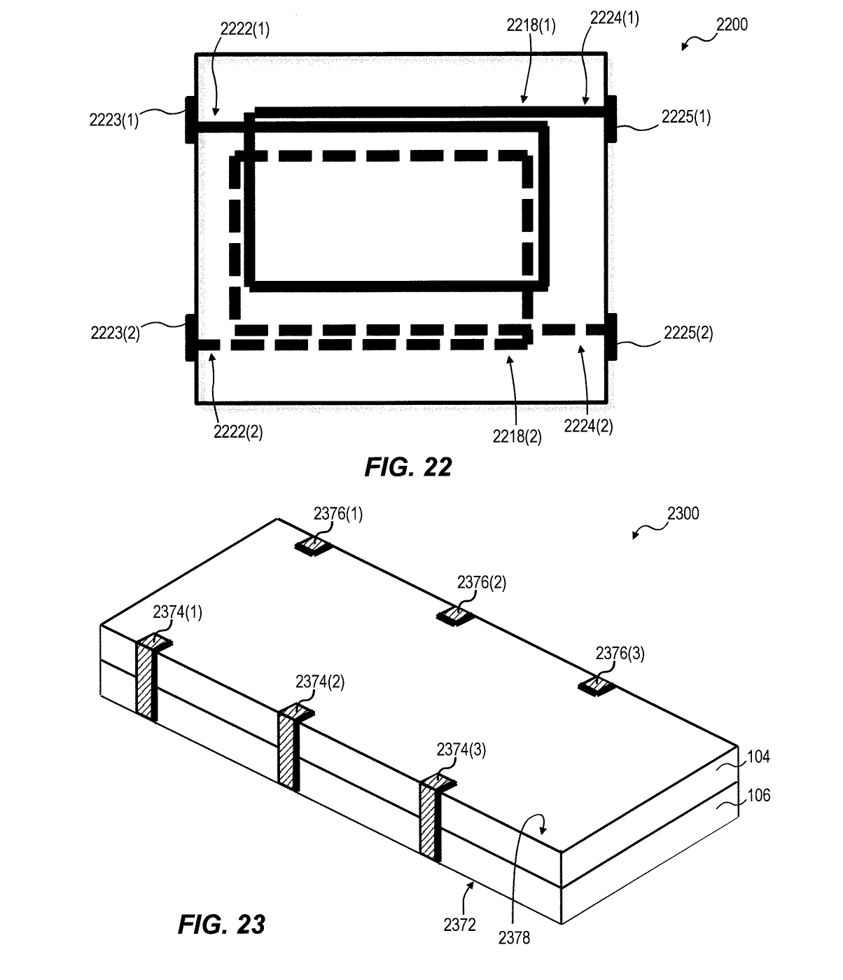

Furthermore, the configuration of windings 2018 could be varied. For example, wire winding 2018 could be replaced with foil windings or conductive film. For example, FIG. 22 shows a top plan view of a coupled inductor array 2200 with its top plate removed. Array 2200 is similar to array 2000 of FIG. 20 but includes windings 2218 formed of conductive film. At least overlapping portions of windings 2218 are insulated from each other, such as by an insulated film (not shown) disposed between overlapping winding portions. In contrast to array 2000, windings ends 2222, 2224 electrically couple to respective solder tabs 2223, 2225, instead of forming through-hole pins.

The configuration of the coupled inductor arrays disclosed herein promotes low height of the arrays, such that certain embodiments may be considered to be “chip-style” coupled inductor arrays. For example, certain embodiments have a height 116 (FIG. 1) of 0.8 millimeters or less.

The relatively low height of such arrays may enable them to be housed in an integrated circuit package with a semiconductor die or bar and optionally electrically coupled to the semiconductor die or bar. For example, certain embodiments of the arrays may be housed in a common integrated circuit package with a semiconductor die, but physically separated from the die within the package. Additionally, certain other embodiments of the coupled inductor arrays disclosed herein are formed on a semiconductor die, such as by disposing a number of layers of magnetic and conductive material on a semiconductor die to respectively form the magnetic core and windings. The semiconductor die and the coupled inductor array, in turn, are optionally housed in a common integrated circuit package, and the coupled inductor is optionally electrically coupled to the semiconductor die.

The examples discussed above show solder tabs being disposed on the coupled inductor array bottom surfaces but not on the array top surfaces. Such configuration may be advantageous in applications where it is desirable that the array top surface being electrically isolated, such as if an optional heat sink is to be disposed on the top surface.

However, certain alternate embodiments include solder tabs on both the top and bottom surfaces of the array. For example, FIG. 23 shows a perspective view of a coupled inductor array 2300, which is similar to coupled inductor array 100 (FIG. 1), but further including solder tabs 2374, 2376 disposed on a top surface 2378, as well as solder tabs 123 (not visible in the FIG. 23 perspective view) disposed on a bottom surface 2372.

### Combinations of Features

Features described above as well as those claimed below may be combined in various ways without departing from the scope hereof. The following examples illustrate some possible combinations:

(A1) A coupled inductor array may include a magnetic core and N windings, where N is an integer greater than one. The magnetic core may have opposing first and second sides, with a linear separation distance between the first and second sides defining a length of the magnetic core. The N windings may pass at least partially through the magnetic core in the lengthwise direction. Each of the N windings may form a loop in the magnetic core around a respective winding axis, and each winding axis may be generally perpendicular to the lengthwise direction and parallel to but offset from each other winding axis. Each winding may have opposing first and second ends extending towards at least the first and second sides of the magnetic core, respectively.

(A2) In the coupled inductor array denoted as (A1), each loop may enclose a respective first area within the magnetic core, where each first area within the magnetic core is at least partially non-overlapping with each other first area in a widthwise direction, perpendicular to the lengthwise direction.

(A3) In the coupled inductor array denoted as (A2), each first area may be completely non-overlapping with each other first area in the widthwise direction.

(A4) In either of the coupled inductor arrays denoted as (A2) or (A3), each loop may be generally planar, and each first area may be less than an area of the magnetic core between the first and second sides in the plane of the respective first area.

(A5) In any of the coupled inductor arrays denoted as (A2) through (A4), each winding axis may be offset from each other winding axis in the widthwise direction within the magnetic core.

(A6) In any of the coupled inductor arrays denoted as (A1) through (A5), the magnetic core may include top and bottom plates, and each loop may be disposed between the top and bottom plates.

(A7) In the coupled inductor array denoted as (A6), the magnetic core may further include N coupling teeth disposed between the top and bottom plates, and each of the N windings may be wound around a respective one of the N coupling teeth.

(A8) In either of the coupled inductor arrays denoted as (A6) or (A7), the magnetic core may further include at least one leakage tooth disposed between the top and bottom plates, where the at least one leakage tooth is disposed between two adjacent ones of the respective loops.

(A9) In the coupled inductor array denoted as (A8), at least one of the N coupling teeth may be formed of a different magnetic material than at least one instance of the at least one leakage tooth.

(A10) Any of the coupled inductor arrays denoted as (A7) through (A9) may further include a non-magnetic spacer disposed between at least one of the N coupling teeth and one of the top plate and the bottom plate.

(A11) In any of the coupled inductor arrays denoted as (A1) through (A5), the magnetic core may be a single-piece magnetic core, with each of the loops being embedded within the single-piece magnetic core.

(A12) In any of the coupled inductor arrays denoted as (A1) through (A11), the N windings may be arranged within the magnetic core such that a current of increasing magnitude flowing into a first of the N windings from the first side of the magnetic core is capable of inducing a current of increasing magnitude flowing into another of the N windings from the first side of the magnetic core.

(A13) In any of the coupled inductor arrays denoted as (A1) through (A12), N may be an integer greater than two.

(A14) In any of the coupled inductor arrays denoted as (A1) through (A13), each loop may be substantially disposed within a common plane in the magnetic core.

(A15) In any of the coupled inductor arrays denoted as (A1) through (A14), each of the loops may be longer in the lengthwise direction than in the widthwise direction.

(A16) In any of the coupled inductor arrays denoted as (A1) through (A15), each of the loops may have a substantially rectangular shape.

(A17) In any of the coupled inductor arrays denoted as (A1) through (A14), each loop may have a substantially circular shape.

(A18) Any of the coupled inductor arrays denoted as (A1) through (A17) may further include a common conductor electrically coupling at least two of the second ends of the N windings.

(A19) In the coupled inductor array denoted as (A18), the common conductor may form a solder tab configured for surface mount attachment to a printed circuit board.

(A20) In any of the coupled inductor arrays denoted as (A1) through (A19), at least one of the N windings may form multiple turns.

(A21) Any of the coupled inductor arrays denoted as (A1) through (A20) may be co-packaged with a semiconductor die.

(A22) Any of the coupled inductor arrays denoted as (A1) through (A20) may be disposed on a semiconductor die.

(A23) Any of the coupled inductor arrays denoted as (A1) through (A20) may be disposed on a semiconductor die and packaged in a common integrated circuit package with the semiconductor die.

(A24) Any of the coupled inductor arrays denoted as (A1) through (A20) may be co-packaged with a semiconductor die and electrically coupled to the semiconductor die.

(A25) Any of the coupled inductor arrays denoted as (A1) through (A20) may be disposed on a semiconductor die and electrically coupled to the semiconductor die.

(A26) Any of the coupled inductor arrays denoted as (A1) through (A20) may be disposed on a semiconductor die, electrically coupled to the semiconductor die, and packaged in a common integrated circuit package with the semiconductor die.

(B1) A multi-phase switching power converter may include a coupled inductor and N switching circuits, where N is an integer greater than one. The coupled may include a magnetic core and N windings. The magnetic core may have opposing first and second sides, with a linear separation distance between the first and second sides defining a length of the magnetic core. The N windings may pass at least partially through the magnetic core in the lengthwise direction, and each of the N windings may form a loop in the magnetic core around a respective winding axis. Each winding axis may be generally perpendicular to the lengthwise direction and parallel to but offset from each other winding axis. Each winding may have opposing first and second ends extending toward at least the first and second sides of the magnetic core, respectively. Each switching circuit may be adapted to be capable of repeatedly switching the first end of a respective one of the N windings between at least two different voltage levels.

(B2) The multi-phase switching power converter denoted as (B1) may further include a controller adapted to control the N switching circuits such that each of the N switching circuits is capable of switching out of phase with respect to at least one other of the N switching circuits.

(B3) In either of the multi-phase switching power converters denoted as (B1) or (B2), each loop may enclose a respective first area within the magnetic core, where each first area within the magnetic core is at least partially non-overlapping with each other first area in a widthwise direction, perpendicular to the lengthwise direction.

(B4) In the multi-phase switching power converter denoted as (B3), each first area may be completely non-overlapping with each other first area in the widthwise direction.

(B5) In either of the multi-phase switching power converters denoted as (B3) or (B4), each loop may be generally planar, and each first area may be less than an area of the magnetic core between the first and second sides in the plane of the respective first area.

(B6) In any of the multi-phase switching power converters denoted as (B1) through (B5), each winding axis may be offset from each other winding axis in the widthwise direction within the magnetic core.

(B7) In any of the multi-phase switching power converters denoted as (B1) through (B6), the magnetic core may include top and bottom plates, and each loop may be disposed between the top and bottom plates.

(B8) In the multi-phase switching power converter denoted as (B7), the magnetic core may further include N coupling teeth disposed between the top and bottom plates, and each of the N windings may be wound around a respective one of the N coupling teeth.

(B9) In either of the multi-phase switching power converters denoted as (B7) or (B8), the magnetic core may further include at least one leakage tooth disposed between the top and bottom plates, where the at least one leakage tooth is disposed between two adjacent ones of the respective loops.

(B10) In the multi-phase switching power converter denoted as (B9), at least one of the N coupling teeth may be fainted of a different magnetic material than at least one instance of the at least one leakage tooth.

(B11) Any of the multi-phase switching power converters denoted as (B8) through (B10) may further include a non-magnetic spacer disposed between at least one of the N coupling teeth and one of the top plate and the bottom plate.

(B12) In any of the multi-phase switching power converters denoted as (B1) through (B6), the magnetic core may be a single-piece magnetic core, with each of the loops being embedded within the single-piece magnetic core.

(B13) In any of the multi-phase switching power converters denoted as (B1) through (B12), the multi-phase switching power converter may include at least one of a multi-phase buck converter, a multi-phase boost converter, and a multi-phase buck-boost converter.

(B14) In any of the multi-phase switching power converters denoted as (B1) through (B13), the N windings may be arranged within the magnetic core such that a current of increasing magnitude flowing into a first of the N windings from the first side of the magnetic core is capable of inducing a current of increasing magnitude flowing into another of the N windings from the first side of the magnetic core.

(B15) In any of the multi-phase switching power converters denoted as (B1) through (B14), N may be an integer greater than two.

(B16) In any of the multi-phase switching power converters denoted as (B1) through (B15), each loop may be substantially disposed within a common plane in the magnetic core.

(B17) In any of the multi-phase switching power converters denoted as (B1) through (B16), each of the loops may be longer in the lengthwise direction than in the widthwise direction.

(B18) In any of the multi-phase switching power converters denoted as (B1) through (B17), each of the loops may have a substantially rectangular shape.

(B19) In any of the multi-phase switching power converters denoted as (B1) through (B16), each loop may have a substantially circular shape.

(B20) Any of the multi-phase switching power converters denoted as (B1) through (B19) may further include a common conductor electrically coupling at least two of the second ends of the N windings.

(B21) In the multi-phase switching power converter denoted as (B20), the common conductor may form a solder tab configured for surface mount attachment to a printed circuit board.

(B22) In any of the multi-phase switching power converters denoted as (B1) through (B21), at least one of the N windings may form multiple turns.

Changes may be made in the above methods and systems without departing from the scope hereof. For example, the number of windings in each array may be varied. Therefore, the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. A coupled inductor array, comprising:
a magnetic core having opposing first and second sides, a linear separation distance between the first and second sides defining a length of the magnetic core; and
N windings passing at least partially through the magnetic core in the lengthwise direction, N being an integer greater than one, each of the N windings forming a loop in the magnetic core around a respective winding axis, each winding axis generally perpendicular to the lengthwise direction and parallel to but offset from each other winding axis, each winding having opposing first and second ends extending towards at least the first and second sides of the magnetic core, respectively.

2. The coupled inductor array of claim 1, each loop enclosing a respective first area within the magnetic core, each first area within the magnetic core at least partially non-overlapping with each other first area in a widthwise direction, perpendicular to the lengthwise direction.

3. The coupled inductor array of claim 2, each winding axis being offset from each other winding axis in the widthwise direction within the magnetic core.

4. The coupled inductor array of claim 3, each loop being generally planar, and each first area being less than an area of the magnetic core between the first and second sides in the plane of the respective first area.

5. The coupled inductor array of claim 4, the magnetic core comprising top and bottom plates, and each loop being disposed between the top and bottom plates.

6. The coupled inductor array of claim 5, the magnetic core further comprising N coupling teeth disposed between the top and bottom plates, each of the N windings wound around a respective one of the N coupling teeth.

7. The coupled inductor array of claim 6, the magnetic core further comprising at least one leakage tooth disposed between the top and bottom plates, the at least one leakage tooth being disposed between two adjacent ones of the respective loops.

8. The coupled inductor array of claim 7, at least one of the N coupling teeth being formed of a different magnetic material than at least one instance of the at least one leakage tooth.

9. The coupled inductor array of claim 7, further comprising a non-magnetic spacer disposed between at least one of the N coupling teeth and one of the top plate and the bottom plate.

10. The coupled inductor array of claim 4, the magnetic core being a single-piece magnetic core, each of the loops being embedded within the single-piece magnetic core.

11. The coupled inductor array of claim 4, the N windings being arranged within the magnetic core such that a current of increasing magnitude flowing into a first of the N windings from the first side of the magnetic core is capable of inducing a current of increasing magnitude flowing into another of the N windings from the first side of the magnetic core.

12. The coupled inductor array of claim 11, N being an integer greater than two.

13. The coupled inductor array of claim 4, each loop being substantially disposed within a common plane in the magnetic core.

14. The coupled inductor array of claim 2, each of the loops being longer in the lengthwise direction than in the widthwise direction.

15. The coupled inductor array of claim 14, each of the loops having a substantially rectangular shape.

16. The coupled inductor array of claim 1, each loop having a substantially circular shape.

17. The coupled inductor array of claim 1, further comprising a common conductor electrically coupling at least two of the second ends of the N windings.

18. The coupled inductor array of claim 17, the common conductor forming a solder tab configured for surface mount attachment to a printed circuit board.

19. The coupled inductor array of claim 1, at least one of the N windings forming multiple turns.

20. The coupled inductor array of claim 1, N being greater than two, each loop enclosing a respective first area within the magnetic core, each first area within the magnetic core completely non-overlapping with each other first area in a widthwise direction, perpendicular to the lengthwise direction.

21. A multi-phase switching power converter, comprising:
a coupled inductor, including:
a magnetic core having opposing first and second sides, a linear separation distance between the first and second sides defining a length of the magnetic core, and
N windings passing at least partially through the magnetic core in the lengthwise direction, N being an integer greater than one, each of the N windings forming a loop in the magnetic core around a respective winding axis, each winding axis generally perpendicular to the lengthwise direction and parallel to but offset from each other winding axis, each winding having opposing first and second ends extending toward at least the first and second sides of the magnetic core, respectively; and
N switching circuits, each switching circuit adapted to be capable of repeatedly switching the first end of a respective one of the N windings between at least two different voltage levels.

22. The multi-phase switching power converter of claim 21, further comprising a controller adapted to control the N switching circuits such that each of the N switching circuits is capable of switching out of phase with respect to at least one other of the N switching circuits.

23. The multi-phase switching power converter of claim 22, each loop enclosing a respective first area within the magnetic core, each first area within the magnetic core at least partially non-overlapping with each other first area in a widthwise direction, perpendicular to the lengthwise direction.

24. The multi-phase switching power converter of claim 23, each winding axis being offset from each other winding axis in the widthwise direction within the magnetic core.

25. The multi-phase switching power converter of claim 24, each loop being generally planar, and each first area being less than an area of the magnetic core between the first and second sides in the plane of the respective first area.

26. The multi-phase switching power converter of claim 25, the magnetic core comprising top and bottom plates and each loop being disposed between the top and bottom plates.

27. The multi-phase switching power converter of claim 26, the magnetic core further comprising:
N coupling teeth disposed between the top and bottom plates, each of the N windings wound around a respective one of the N coupling teeth; and
at least one leakage tooth disposed between the top and bottom plates, the at least one leakage tooth being disposed between two adjacent ones of the respective loops.

28. The multi-phase switching power converter of claim 21, the magnetic core being a single-piece magnetic core, each of the loops being embedded within the single-piece magnetic core.

29. The multi-phase switching power converter of claim 21, the multi-phase switching power converter comprising at least one of a multi-phase buck converter, a multi-phase boost converter, and a multi-phase buck-boost converter.

30. The multi-phase switching power converter of claim 21, N being greater than two, each loop enclosing a respective first area within the magnetic core, each first area within the magnetic core completely non-overlapping with each other first area in a widthwise direction, perpendicular to the lengthwise direction.

31. An electronic device, comprising:
an integrated circuit package;
a semiconductor die housed in the integrated circuit package; and
a coupled inductor housed in the integrated circuit package and electrically coupled to the semiconductor die, the coupled inductor including:
a magnetic core having opposing first and second sides, a linear separation distance between the first and second sides defining a length of the magnetic core, and
N windings passing at least partially through the magnetic core in the lengthwise direction, N being an integer greater than one, each of the N windings forming a loop in the magnetic core around a respective winding axis, each winding axis generally perpendicular to the lengthwise direction and parallel to but offset from each other winding axis, each winding having opposing first and second ends extending toward at least the first and second sides of the magnetic core, respectively.

32. The electronic device of claim 31, the coupled inductor being disposed on the integrated circuit die.
